(19) United States
(12) Patent Application Publication
(10) Pub. No.: US 2003/0133022 A1
(43) Pub. Date: Jul. 17, 2003

(54) Digital video editing device and method

(76) Inventor: Gerod C. Melton, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/047,849

(22) Filed: Jan. 15, 2002

(51) Int. Cl. H04N 5/76

(52) U.S. Cl. 348/231.2

(57) ABSTRACT

A digital video device includes a processor and a digital random-access memory communicating with the processor. The memory includes an edit tag library storing a plurality of edit tags and video storage storing a digital video data. The digital video data includes one or more video segments and one or more embedded edit tags. The one or more embedded edit tags are selected from the edit tag library and specify edit operations to be performed on the digital video data.

### FIELD OF THE INVENTION

The present invention relates generally to video editing, and more particularly to digital video editing.

### BACKGROUND OF THE INVENTION

Digital video cameras are widely used for many types of image capturing, such as filming family scenes, important events, etc. A digital video camera is held and operated by a user in order to selectively record segments of video. Digital video cameras typically capture a sequence of digital images, with each image comprising a large number of data bytes. The digital data is stored on a magnetic tape, such as a VHS tape or 8-millimeter tape, for example.

In the prior art, the video capturing process may be done manually, such as by the user manipulating video camera controls, or by voice control. A voice controlled video camera having voice control over record functions is given in U.S. Pat. No. 5,548,335 to Mitsuhashi et al.

The video capturing process may be followed by an editing process. The editing of the captured video is a process of removing unwanted or unsatisfactory portions of captured recorded video. It may also include the reordering of segments, adding fade-in/fade-out, adding titles or graphics, inserting new segments, etc.

In the prior art approach, the video editing has typically been done by hand, with the human editor fast-forwarding, rewinding, playing, and erasing the magnetic video tape. This is slow, tedious, and cumbersome. Furthermore, the hand editing may result in a loss of image quality if the original video tape is re-recorded one or more times during the editing process.

Another prior art approach to video editing has been an automated approach, typically done by elaborate and expensive computerized equipment. In this prior art approach, the video is copied from the video tape and then is digitally manipulated on a specialized editing machine. Therefore, the data may need to be copied multiple times in order to remove and/or move portions of the video data. However, such automated editing is beyond the resources of all but a few, and is typically only available to video professionals.

Therefore, there remains a need in the art for improvements to video editing.

### SUMMARY OF THE INVENTION

A digital video device comprises a processor and a digital random-access memory communicating with the processor. The memory includes an edit tag library storing a plurality of edit tags and video storage storing digital video data. The digital video data comprises one or more video segments and one or more embedded edit tags. The one or more embedded edit tags are selected from the edit tag library and specify edit operations to be performed on the digital video data.

### BRIEF DESCRIPTION OF THE DRAWINGS

FIG. 1 is a schematic of a digital video device according to one embodiment of the invention;

FIG. 2 is a flowchart of a digital editing method according to one embodiment of the invention;

FIG. 3 is a flowchart of a pre-edit method according to an embodiment of the invention;

FIG. 4 is a flowchart of a pre-edit method according to another embodiment of the invention;

FIG. 5 is a flowchart of a final edit method according to another embodiment of the invention;

FIG. 6 shows a captured video data comprising multiple video segments A through D;

FIG. 7 shows the video data after the marked video segments have been deleted;

FIG. 8 shows the video data after the remaining video segments have been re-ordered; and

FIG. 9 shows a video segment T that is to be trimmed.

### DETAILED DESCRIPTION

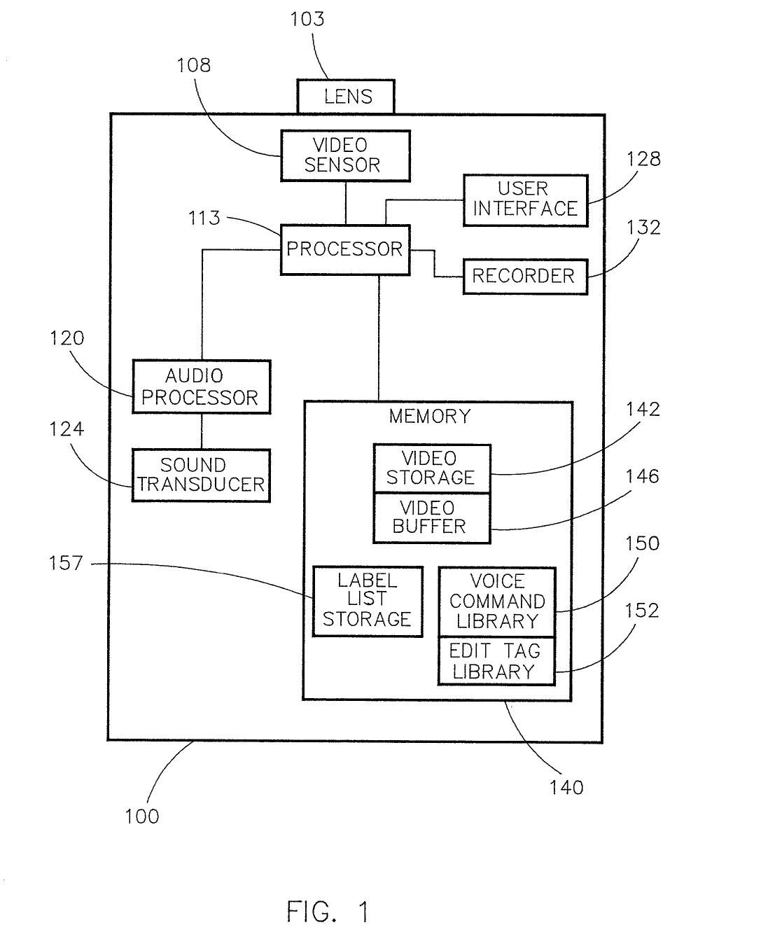

FIG. 1 is a schematic of a digital video device 100 according to one embodiment of the invention. The digital video device 100 includes a processor 113, a user interface 128, and a digital memory 140. In addition, the digital video device 100 may optionally include a sound transducer 124 and an audio processor 120. If the digital video device 100 is a digital video recorder (i.e., a digital video camera or camcorder), the digital video device 100 may include a lens 103, a video sensor 108, and a recorder 132.

The processor 113 may be any type of general purpose processor. The processor 113 executes a control routine contained in the digital memory 140. In addition, the processor 113 receives inputs and conducts operations of the digital video device 100.

The digital memory 140 may be any type of random access digital memory, including a transistor-based memory, a writable DVD, a writable CD, an IBM microdrive, a fluorescent multi-layer device (FMD) storage medium, etc. The digital memory 140 may store, among other things, a video storage 142, an optional video buffer 146, a voice command library 150, an edit tag library 152, and a label list storage 157. In addition, the digital memory 140 may store software or firmware to be executed by the processor 113.

The video storage 142 stores captured digital video data. The video data may comprise one or more video segments, with a video segment comprising a number of frames of video data captured from a record start to a record stop operation of a digital video recorder. The length of the captured digital video may depend on the frame rate, the type of compression, the resolution, the amount of available memory, etc.

The video buffer 146 is an optional component and may be used for the editing process. The video buffer 146 therefore may be a temporary digital memory storage area to be used for manipulating digital video segments. The contents of the video buffer 146 may later be written to another memory, such as to the video storage 142 or to the optional recorder 132.

The voice command library 150 stores voice commands recognized by the digital video device 100. A portion of audio input may be compared to stored voice commands in the voice command library 150 in order to recognize certain words, commands, and/or phrases. The voice command library 150 therefore may be used to convert captured speech into voice commands and edit tags to be used by the digital video device 100.

The edit tag library 152 stores edit tags that may be embedded into a captured video data. The edit tag library 152 may be used in conjunction with the voice command library 150 to vocally generate and insert edit tags into the captured video data. Therefore, the user of the digital video device 100 may vocalize edit commands that may later be acted upon by the digital video device 100 in order to easily and quickly edit a video image captured within the digital memory 140. Alternatively, the user may employ a graphical user interface to select edit tags and to place them into the captured video data, such as through the user interface 128.

The optional label list storage 157 stores a listing of labels of associated video segments in the video storage 142. The label list storage 157 may be employed by the user to review and edit the captured video data. These labels may be automatically generated or optionally may be created by the user. The user therefore can review all of the video segment labels and may use this knowledge during the editing process. By using the video segment labels, the user may determine whether to delete any segments, to trim portions of any segments, whether to re-order the video segments, etc.

The audio processor 120 and sound transducer 124 are optional components that may be included for picking up the voice of a human operator of the digital video device 100. The sound transducer 124 may be a microphone, and may be included in the digital video device 100 in addition to a regular recording microphone. The sound transducer 124 may optionally be a directional microphone or may include a wireless microphone or a microphone that plugs into a port in the digital video device 100. The sound transducer 124 may pick up voice commands. The audio processor 120 processes the audio signal from the sound transducer 124 and detects speech in the audio signal. The audio processor 120 may be a specialized processor, such as a digital signal processor (DSP), etc., that can pick out voice commands, edit tags, etc.

The optional video sensor 108 may be any type of video sensor capable of converting an image into a corresponding array of pixel values. The video sensor 108 may be, for example, a charge-coupled device (CCD) sensor or a complementary metal oxide semiconductor (CMOS) sensor.

The optional recorder 132 may be any type of video recorder employing any type of video recording medium. This may include a magnetic tape, a writable digital video disk (DVD), a writable compact disk (CD), or other form or recordable medium. It should be noted that although the digital video device 100 according to the invention typically stores the digital video data to the video storage 142, it may also record digital video data to some other medium for long-term storage, using the optional recorder 132. Therefore, after the digital video device 100 has finished editing a video data, the video data may then be copied or transferred to a magnetic tape medium, for example, using the recorder 132.

The user interface 128 may be any type of user interface that accepts inputs and allows a user to control operations of the digital video device 100. The user interface 128 may include regular input buttons or switches usable to operate the digital video device 100. In addition, the user interface 128 may include a link, such as a wire or infrared (IR) link that accepts external command inputs. This may include, for example, a remote control used to operate the digital video device 100. In addition, the user interface 128 may include a display (not shown). The display may be used for showing operational characteristics of the digital video device 100, and may additionally show an input menu or other input structure. This may include a touch screen for showing an array of possible inputs, with the touch screen able to accept resulting input selections from the user.

The invention may apply to any digital video device 100 that includes a digital memory 140. The digital video device 100 may be a digital video recorder that is capable of capturing video in the form of digital video data. Alternatively, a previously recorded video data may be downloaded to the digital video device 100, wherein the digital video device 100 does not have to be capable of capturing video but only has to be capable of receiving and storing the digital video data. Therefore, the digital video device 100 may be any manner of digital device that can store and process digital data, including a personal computer (PC), for example.

In operation, video data may be captured to the video storage 142. The video capture may be regulated by the processor 113. Alternatively, a video data may be received from another device, such as from a digital video recorder, for example. Because the video storage 142 is part of a digital (random-access) memory 140, the processor 113 can randomly access any portion of the video data in a substantially instantaneous manner. In addition, the user can vocally embed edit tags into the video storage 142. These edit tags may then be used by the processor 113 to perform corresponding edit functions, such as deleting sections of video data, moving sections of video data, adding special effects, etc.

In one embodiment of the digital video device 100, the sound transducer 124 and audio processor 120 are used to receive voice commands from the voice of the user. The sound transducer 124 receives sound and generates an audio signal in response. The audio processor 120 receives the audio signal and compares the contents of the audio signal to the voice command library 150 in order to recognize verbalized words in the audio signal. The recognized voice command and/or edit tags may then be employed to control the operation of the digital video device 100. The voice commands may include, for example, edit tag insert commands, final edit activation commands, edit tag removal commands, label insertion and removal commands, etc. In addition, if the digital video device 100 is a digital video recorder, the voice commands may include operational commands such as record, play, stop, eject, fade-in, fade-out, power-on and off, etc.

There may be many voice commands that may be used during a pre-edit or a final edit mode. A number edit command may specify that the digital video device 100 play a predetermined portion of each video segment. An add edit command may specify that the digital video device 100 add a current video data segment as a next segment in a finished video program, and proceed to a next video data portion (i.e., the add edit command is used to add segments to a finished video program being assembled in the memory 140). An edit check command may specify that the digital video device 100 play video segments of the stored video data according to a predetermined order (i.e., the user can specify that the video segments be played in an order other than in which they were recorded). This command is useful for checking out a new video segment order before actually reordering any of the segments. A front edit command may specify that the digital video device 100 set an edit session variable to a beginning of the stored video data. This may be useful when processing or viewing individual video segments during the pre-edit mode. A find edit command may specify that the digital video device 100 find a specified label embedded in a particular video segment. A forward edit command may specify that the digital video device 100 move forward through the captured video data at a predetermined speed. A back edit command may specify that the digital video device 100 move backward through the captured video data at a predetermined speed. A clean-up edit command may specify that the digital video device 100 de-fragment the video storage 142. An edit-on edit command may specify that the digital video device 100 enter a final edit mode, wherein embedded edit tags are acted on by the digital video device 100. A skip edit command may specify that the digital video device 100 skip from a current video segment to a next video segment.

It should be understood that the edit commands listed and described above are given merely for example, and the listing is not exhaustive. Other edit commands may be included and employed in the digital video device 100.

In another embodiment of the digital video device 100, the sound transducer 124 and audio processor 120 are used to recognize verbalized edit tags from the voice of the user. Again, the sound transducer 124 receives sound and generates an audio signal in response. The audio processor 120 receives the audio signal and compares the contents of the audio signal to the edit tag library 152 in order to recognize verbalized words in the audio signal. The extracted voice command and/or edit tags may then be employed in the digital video device 100.

Edit tags also may be used to control the final editing operation, wherein the digital video device 100 performs edit operations specified by the embedded edit tags. The digital video device 100 therefore scans the digital signal in the video storage 142 and finds all embedded edit tags. Each edit tag may be acted on when found. The user may therefore control the final edit operation by generating and embedding appropriate edit tags.

There may be a variety of edit tags that may be used during a pre-edit and a final edit mode. A delete edit tag may specify that the video segment (in which the delete edit tag is embedded) be deleted. This edit tag may be used to delete an entire video segment. An edit trim start and edit trim stop edit tags may specify a portion of a video segment to be deleted (see FIG. 9 and accompanying discussion). This edit tag pair may be used to delete a video segment portion of any size. For example, if the user has recorded ten minutes of a party, but wants to keep only the first four minutes, the user may delete the unwanted six minutes by bracketing the six minute segment with the edit trim start and edit trim stop edit tags. The edit trim start and edit trim stop edit tags will be acted on in the final edit mode, where the bracketed portion will be deleted. A label insert edit tag may specify insertion of a user-defined label. The label may be inserted if the original recording did not create a label, or may be inserted if the original label was automatically created and the user wants to create a more descriptive label. Alternatively, the label insert edit tag may be used to insert a label into a video segment in order to divide the video segment into two video segments. A re-ordering edit tag may specify a change in order of the video segments. For example, a user may insert re-ordering edit tags that specify the new positions for segments, such as a position 4 where the segment is currently segment 3. Alternatively, the re-ordering edit tag could merely specify a shift of the video segment to the left by one segment, to the right by one segment, etc. A fade edit tag may specify a fade out/fade in between the current video segment and a next video segment.

It should be understood that the edit tags listed and described above are given merely for example, and the listing is not exhaustive. Other edit tags may be included and employed in the digital video device 100.

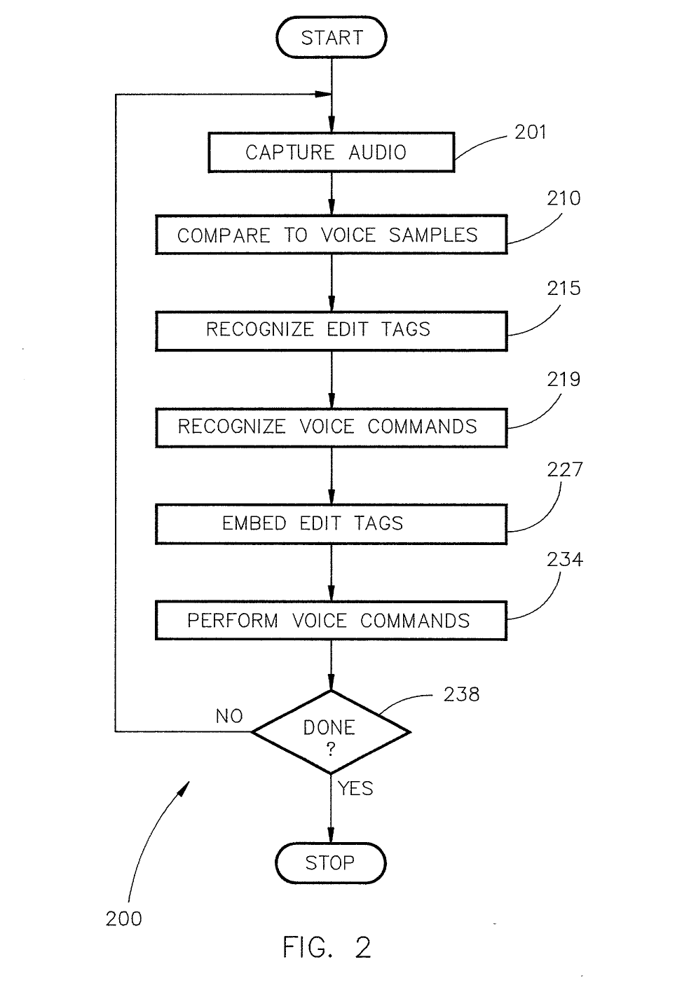

FIG. 2 is a flowchart 200 of a digital editing method according to one embodiment of the invention. In step 201, an audio signal is captured. The capturing may be performed by the sound transducer 124 and the audio processor 120.

In step 210, the captured audio signal is compared to voice samples. The voice samples may be stored in the voice command library 150, for example. The comparison may include a sliding window, wherein a time window of the captured audio signal are compared to the voice samples stored in the voice command library 150. By comparing the audio signal to known voice commands or known edit tags, any voice commands or edit tags in the captured audio signal may be identified.

In step 215, the digital video device 100 recognizes vocalized edit tags in the captured audio signal. This may be achieved by comparing recognized speech units to the contents of the edit tag library 152.

In step 219, voice commands within the captured audio signal are recognized.

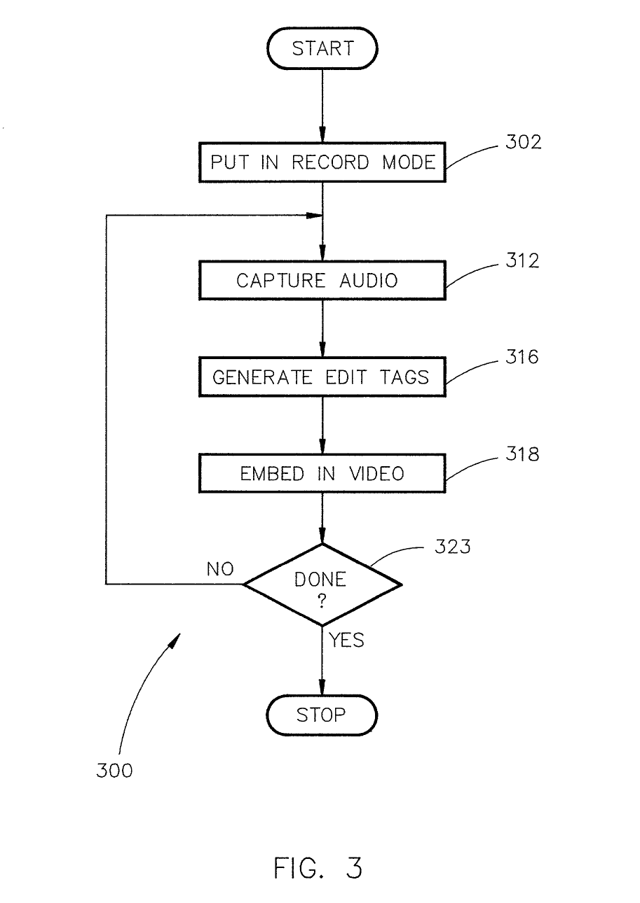

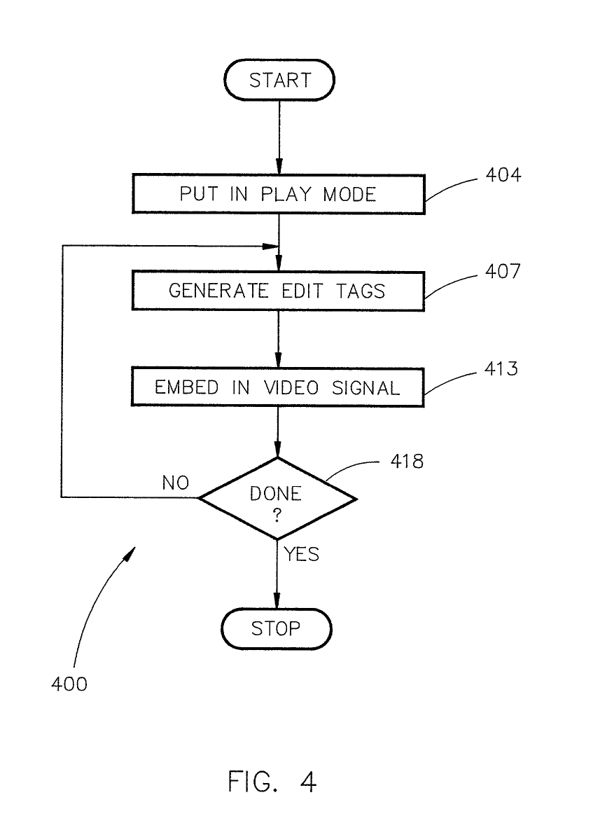

In step 227, any found edit tags are embedded in the stored digital video data, at a point in time when the edit tag is recognized. This may include embedding the edit tags when in a record mode or in a review (play) mode (discussed below in conjunction with FIGS. 3 and 4).

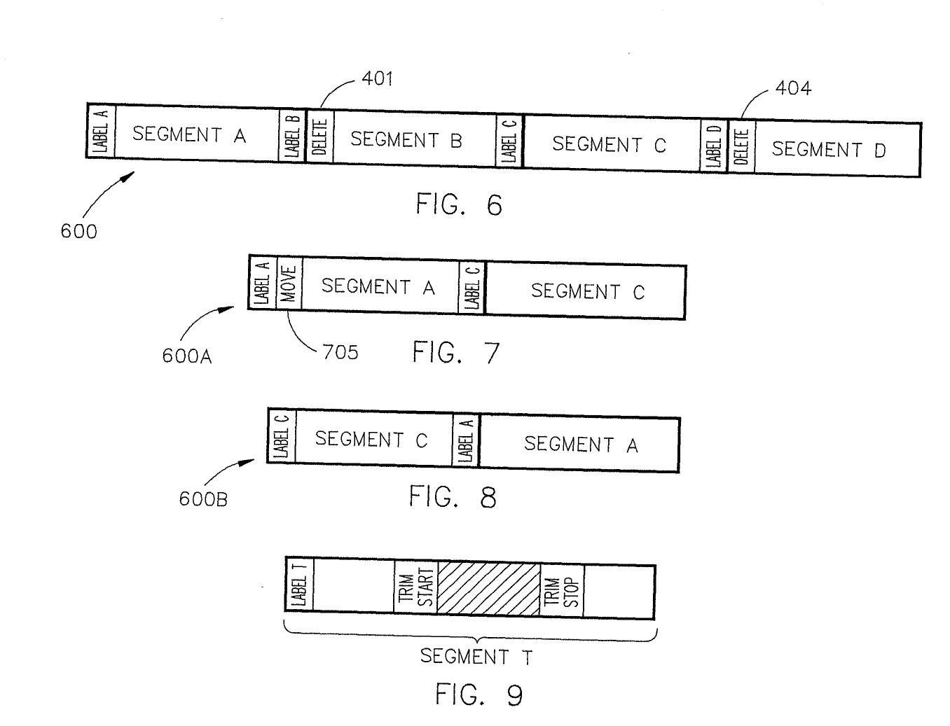

In step 234, any recognized voice commands are performed. This may include, for example, control commands for operating the digital video device 100 (i.e., on/off, record, play, stop, fast-forward, rewind, etc.). This may further include edit commands that operate in conjunction with any embedded edit tags (i.e., activate a video segment trim operation, activate a video segment re-ordering operation, activate a video segment delete operation, etc. (discussed below in conjunction with FIGS. 6-9)).

In step 238, the method checks to see if all captured audio has been processed. If the digital video device 100 is still in an audio capture mode, the method branches back to step 201; otherwise, it exits.

FIG. 3 is a flowchart 300 of a pre-edit method according to an embodiment of the invention. The pre-edit mode is a mode in which edit tags may be inserted, removed, etc., in preparation for the actual editing process. Therefore, in the pre-edit mode one or more edit tags may be embedded into a video data as it is captured. In step 302, the digital video device 100 is put into a record mode (this method only applies if the digital video device 100 is a digital video recorder device). In the record mode, the video data is being captured to the video storage 142. In addition, the record mode may automatically record a label for each segment that is being captured (i.e., the digital video device 100 is a digital video recorder and it generates a label each time the digital video recorder goes into the record mode).

In step 312, a video data is captured to the video storage 142 of the digital memory 140. The video storage 142 is part of a random-access memory, as previously discussed.

In step 316, the user may concurrently generate edit tags. This may be done by capturing vocal edit tags in a captured audio signal. Alternatively, the user may manipulate the user interface 128 in order to graphically select from among displayed edit tag options and therefore to generate edit tags. For example, the user may press an input button or device to select an edit trim tag.

In step 318, the generated edit tags are concurrently embedded into the video data as it is being captured. Therefore, in this method embodiment the user may generate and insert edit tags during the recording process, as events happen and are captured in the video data. This speeds up the editing process, and makes editing as easy as talking to the video recorder device 100 as the recording is taking place.

In step 323, if the recording mode is still ongoing, the method branches back to step 312, otherwise it exits.

FIG. 4 is a flowchart 400 of a pre-edit method according to another embodiment of the invention. In this method embodiment, the digital video data has already been captured and is being reviewed for purposes of inserting edit tags and editing. In step 404, the digital video device 100 is put into a play mode. In the play mode, the captured video data is played back to and reviewed by the user.

In step 407, the user generates edit tags during the playback of the captured video data. This may be done by capturing vocalized edit tags or by manually or remotely manipulating the user interface 128, as previously discussed.

In step 413, the edit tags are concurrently embedded into the video data as it is being played back. Therefore, the user may generate and insert edit tags during the playback process and into a previously recorded video data.

In step 418, if the playback mode is still ongoing, the method branches back to step 407, otherwise it exits.

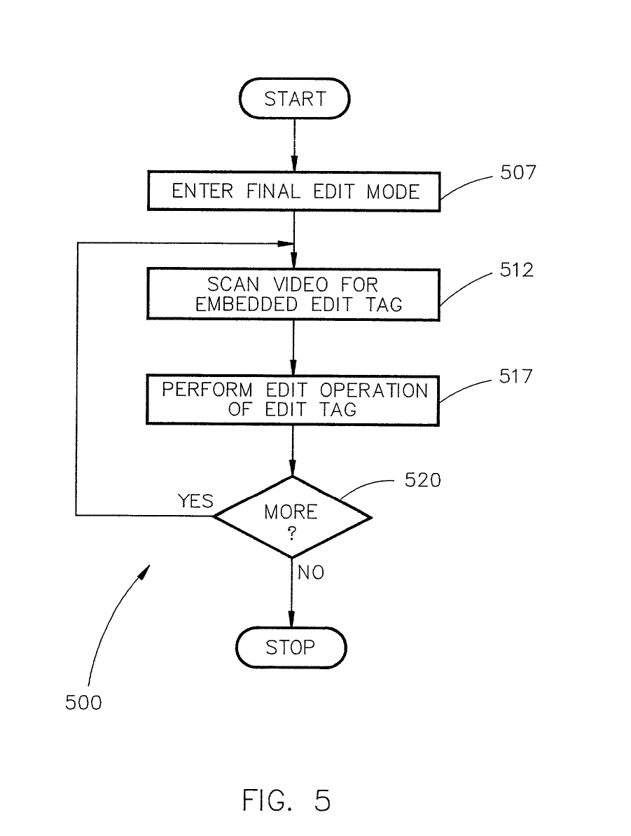

FIG. 5 is a flowchart 500 of a final edit method according to another embodiment of the invention. In the final edit method, the embedded edit tags are acted upon in order to perform the actual edit operations specified by the embedded edit tags. In step 507, the digital video device 100 enters a final edit mode.

In step 512, the captured digital video data is scanned for an embedded edit tag.

In step 517, the operation corresponding to a found edit tag is performed. This may involve using the edit tag library 152 to map an edit tag to an operation. An edit tag may be associated with one or more operations, and conversely more than one edit tag may be required for a single operation (i.e., both a trim start tag and a trim stop tag may be needed in order to perform a trim operation, wherein a video segment between the two tags is removed from the digital memory 140).

In step 520, the method checks for more embedded edit tags (a captured digital video data may contain multiple embedded edit tags). If more edit tags exist, the method branches back to step 512; otherwise, it exits.

FIG. 6 shows a captured video data 600 comprising multiple video segments A through D. Each segment may include a label. The label may be generated by the user, or may be automatically generated by the digital video recorder devices used to capture the video data 600. In this example, the user wants to delete some segments and re-order the remaining segments. Therefore, the user has already inserted two delete edit tags 401 and 404.

FIG. 7 shows the video data 600a after the marked video segments have been deleted. The video data 600a also includes a “move” edit tag 705 (not previously shown for clarity).

FIG. 8 shows the video data 600b after the remaining video segments have been re-ordered, according to the “move” edit tag 705a.

FIG. 9 shows a video segment T that is to be trimmed. Trimming is a deletion of only a portion of the video segment. Here, the segment to be deleted is delimited by a trim start edit tag and a trim stop edit tag. The cross-hatched video segment portion will be deleted in a final edit mode, when any embedded edit tags are acted upon.

The digital video editing according to the invention may apply to any manner of digital video device employing random-access memory, including a digital video recorder. The editing portion of the invention may further apply to any digital video device that can download and manipulate digital video data, including a personal computer or a custom computerized editing device. This may include a specialized DVD or CD writer, wherein the device can randomly access the digital video data within a digital memory.

The invention differs from the prior art in that prior art editing operated on magnetic tape. The inherent drawbacks in such a prior art editing are the lengthy fast-forward and rewind times, such as during a search for a video segment. It is therefore difficult for a user to find a beginning and end of a video segment on prior art editing equipment. Moreover, the prior art editing approach is mechanically stressful to the decks and to the magnetic tape.

The digital video editing according to the invention provides many benefits. The digital video editing according to the invention is easy to use, especially for non-video professionals. It provides a low cost editing capability. It provides a faster editing and a corresponding ease of finding a beginning and ending of a video segment (no fast-forwarding or rewinding are needed in the random-access memory storage approach of the invention). A user can instantly proceed to a particular video segment and can automatically scan video segments. The user can delete unwanted video segments and can trim unwanted portions of video segments. As a result, the user can manage and conserve digital memory space.

In an additional benefit, the user can control the digital video device in a simplified fashion using voice commands (including but not limited to edit operations). Therefore, there is no need for mechanical devices and the accompanying maintenance problems and costs.

We claim:

1. A digital video device, comprising:
a processor; and
a digital random-access memory communicating with said processor and including an edit tag library storing a plurality of edit tags and a video storage storing digital video data comprising one or more video segments and one or more embedded edit tags, with said one or more embedded edit tags being selected from said edit tag library and specifying edit operations to be performed on said digital video data.

2. The digital video device of claim 1, further comprising:
a sound transducer receiving sound and generating an audio signal in response;
an audio processor communicating with said processor and said sound transducer, said audio processor receiving said audio signal, extracting one or more voice commands from said audio signal, extracting one or more edit tags from said one or more voice commands, and passing said one or more voice commands and said one or more edit tags to said processor.

3. The digital video device of claim 2, wherein said sound transducer, said audio processor, and said processor are used to control operations of said digital video device according to said voice commands.

4. The digital video device of claim 2, wherein said sound transducer, said audio processor, and said processor extract vocalized edit tags and embed said edit tags in said digital video data stored in said video storage.

5. The digital video device of claim 1, further comprising a digital image sensor communicating with said processor and capable of generating digital video data, wherein said digital video device comprises a digital video recorder.

6. The digital video device of claim 1, further comprising a user interface capable of accepting user inputs, including accepting edit tag inputs.

7. The digital video device of claim 1, said digital memory further including a voice command library storing a plurality of voice commands, and wherein a voice sample is compared to said voice command library in order to recognize one or more voice commands from said audio signal.

8. The digital video device of claim 1, said digital memory further including a label list storage storing all video segment labels of digital video data stored in said video storage.

9. A video edit method for a digital video device, comprising the steps of:
generating one or more edit tags; and
embedding said one or more edit tags into digital video data stored in a digital memory;
wherein said one or more edit tags delineate one or more edit operations to be performed on one or more video segments of said digital video data.

10. The method of claim 9, wherein the generating and embedding steps occur when said digital video device is in a video record mode.

11. The method of claim 9, wherein the generating and embedding steps occur when said digital video device is in a video review mode.

12. The method of claim 9, wherein an embedded edit tag of said one or more edit tags comprises a digital symbol that represents a captured, vocalized edit tag.

13. The method of claim 9, wherein an embedded edit tag of said one or more edit tags comprises a digital symbol that represents a captured, vocalized edit tag and wherein the step of generating one or more edit tags further comprises the steps of:
capturing an audio signal;
recognizing one or more voice commands from said audio signal; and
correlating said one or more voice commands to a predetermined library of edit tags in order to detect said one or more edit tags.

14. The method of claim 13, further comprising the step of employing a recognized voice command to control an operation of said digital video device.

15. The method of claim 9, further comprising the steps of:
scanning said digital video data for embedded edit tags; and
performing an edit operation specified by each found edit tag.

16. The method of claim 15, wherein the scanning and performing steps are iteratively performed for an entire length of said digital video data.

17. A video edit method for a digital video device, comprising the steps of:
generating one or more edit tags;
embedding said one or more edit tags into digital video data stored in a digital memory, with said one or more edit tags delineating one or more edit operations to be performed on one or more video segments of said digital video data;
scanning said digital video data stored in a digital memory for embedded edit tags; and
performing an edit operation specified by each found edit tag.

18. The method of claim 17, wherein an embedded edit tag of said one or more edit tags comprises a digital symbol that represents a captured, vocalized edit tag.

19. The method of claim 17, wherein the scanning and performing steps are iteratively performed for an entire length of said digital video data.
